(19) United States
(12) Patent Application Publication
(10) Pub. No.: US 2025/0118298 A1
(43) Pub. Date: Apr. 10, 2025

(54) SYSTEM AND METHOD FOR OPTIMIZING A USER INTERACTION SESSION WITHIN AN INTERACTIVE VOICE RESPONSE SYSTEM

(71) Applicant: HISHAB SINGAPORE PRIVATE LIMITED, Singapore (SG)

(72) Inventors: Tareq Al MUNTASIR, Mirpur DOHS (BD); Md. Tariqul ISLAM, Chattogram (BD); Sheikh Asif IMRAN, Dhaka Uttar City corporation (BD)

(73) Assignee: HISHAB SINGAPORE PRIVATE LIMITED, Singapore (SG)

(21) Appl. No.: 18/378,118

(22) Filed: Oct. 9, 2023

(51) Int. Cl. G10L 15/22; G10L 13/08; G10L 15/04; G10L 15/26; H04M 3/493

(52) U.S. Cl. CPC G10L 15/22; G10L 13/08; G10L 15/04; G10L 15/26; H04M 3/4936

(57) ABSTRACT

The present invention describes a system and a method for monitoring and optimizing a user interaction session within an interactive voice response system during a human-computer interaction, the user interaction management system (100) for monitoring and optimizing the user interaction session comprising a conversation controller module (109), the conversation controller module (109) receives the audio features and processes outputs of ASR and NLU during the user interaction session to optimize the user interaction session duration. According to an embodiment of the present invention, the conversation controller may suggest the TTS to increase the rate of speech. According to yet another embodiment, the conversation controller may suggest the TTS to decrease the rate of speech.

### FIELD OF INVENTION

The present invention relates to monitoring and control of conversation and user interaction sessions of an interactive voice response system and more particularly to systems and methods to improve the user interaction by optimizing the interaction session duration in an interactive voice response system.

### BACKGROUND OF THE INVENTION

In general, a user journey is described as the different steps taken by users to complete a specific task within a system, application, or website. For a dialogue engine, the user journey is defined as the timespan from the user (sentence or input) initiating a conversation to trigger a service to a completion of the service (when the dialogue engine finishes announcing that the intended service has been successfully provided). However, in a user interaction session in an interactive voice response system using a dialogue engine, the user journey duration is impacted by several phenomenon, such as the time taken to predict silence intervals and turn transitions, Text to Speech (TTS) processes, natural language understanding (NLU) model performance, and the conversation path design. Misalignment in either of the phenomena costs the user both time and energy and also costs the system time, overload on the ASR and the server, and further operating expenses, respectively. Consequently, the user may not find the interface of the system user-friendly and may encounter difficulties when completing lengthy information such as the phone number etc. due to lack of better silence detecting mechanism and therefore, may be reluctant to use the system interface in the future. Furthermore, given the current scenario, in a dialogue management system in an IVR communication system, the ASR and the Natural Language Understanding (NLU) pipeline of a user interface driving entity needs to be manually adapted and executed for each and every classified case. Therefore, it is hard to maintain on a large scale. As a result, a plurality of cases are missed or poorly navigated which harms the progressivity of a conversation.

Optimization of at least one of the phenomena can optimize the user journey duration. For example, if the number of turn transitions is optimized, then the number of times the ASR model needs to infer audios would be reduced and furthermore, the number of times the TTS model needs to convert text to speech would be reduced as well. This would also result in reducing the size of the server necessary to provide service to a plurality of concurrent users or, furthermore, increasing the number of users that can be concurrently served via the configuration.

Therefore, a need exists, for an improvement, a solution that is flexible and can improve the user journey, test, recognize and fix errors in the background without disrupting the user interaction session while also saving both cost for the operation and the user's usage.

### SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Generally, in a conventional dialog management system, a plurality of text analysis and tuning tools, and optimization tools are adapted and operated separately and manually which has the problem of complexities and cost. Unprecedented cases and misalignments are identified based on human feedback and initiatives are taken based on that manually. Misalignment in the interaction sessions costs the user both time and energy. Consequently, the user may not find the interface of the system user-friendly and may encounter difficulties when completing lengthy information such as the phone number, for example. To overcome the above associated problems, the present invention describes a system and method for improving user interaction sessions through optimizing the interaction session duration in an interactive voice response system by determining errors and efficiently developing, and deploying fixes to optimize and maintain the user journey. According to an embodiment of the present invention, a conversation controller is used which is capable of automatically triggering actions based on results obtained from the session monitoring module and user profile database to perform desired intent fulfillment operations thereby, optimizing the user journey and its duration. The system and method for user interaction session management further includes applying sentiment analysis to focus and work on a specific component. Therefore, it enhances user journey duration and experience, measures and reduces the uncertainty and classification errors, and misalignments within the interaction session in the system. This makes the interface more efficient, and approachable. Furthermore, it also has the added advantages of saving time and cost for both the system operations and the user's usage.

Implementations may include one or more of the following features.

### BRIEF DESCRIPTION OF DRAWINGS

The drawing figures show one or more implementations by way of example only, and not by way of limitation. In the drawings, like reference numerals indicate the same or similar elements.

FIG. 1A is a block diagram illustrating data transmitted and received during an interaction session between a user and an IVR communication system 100 for monitoring and optimizing a user interaction session using a conversation controller.

FIG. 1B is a block diagram illustrating data flow data transmitted and received during an interaction session between a user and an IVR communication system 120 for monitoring and optimizing a user interaction session using a conversation controller.

FIG. 2 is a flowchart illustrating a process 200 for determining speech segments, and/or non-speech segments.

FIG. 3 is a flowchart illustrating a process 300 for the conversation controller integration in an exemplary scenario.

### DETAILED DESCRIPTION OF THE INVENTION

Described herein are methods and systems for monitoring and optimizing a user interaction session within an interactive voice response system during human-computer interaction. The systems and methods are described with respect to figures and such figures are intended to be illustrative rather than limiting to facilitate explanation of the exemplary systems and methods according to embodiments of the invention.

The foregoing description of the specific embodiments reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

As used herein, the term “network” refers to any form of a communication network that carries data and is used to connect communication devices (e.g. phones, smartphones, computers, servers) with each other. According to an embodiment of the present invention, the data includes at least one of the processed and unprocessed data. Such data includes data which is obtained through automated data processing, manual data processing or unprocessed data.

As used herein, the term “artificial intelligence” refers to a set of executable instructions stored on a server and generated using machine learning techniques.

Although the following description uses terms “first,” “second,” etc. to describe various elements, these elements should not be limited by the terms. These terms are only used to distinguish one element from another. For example, a first intent could be termed a second intent, and, similarly, a second intent could be termed a first intent, without departing from the scope of the various described examples.

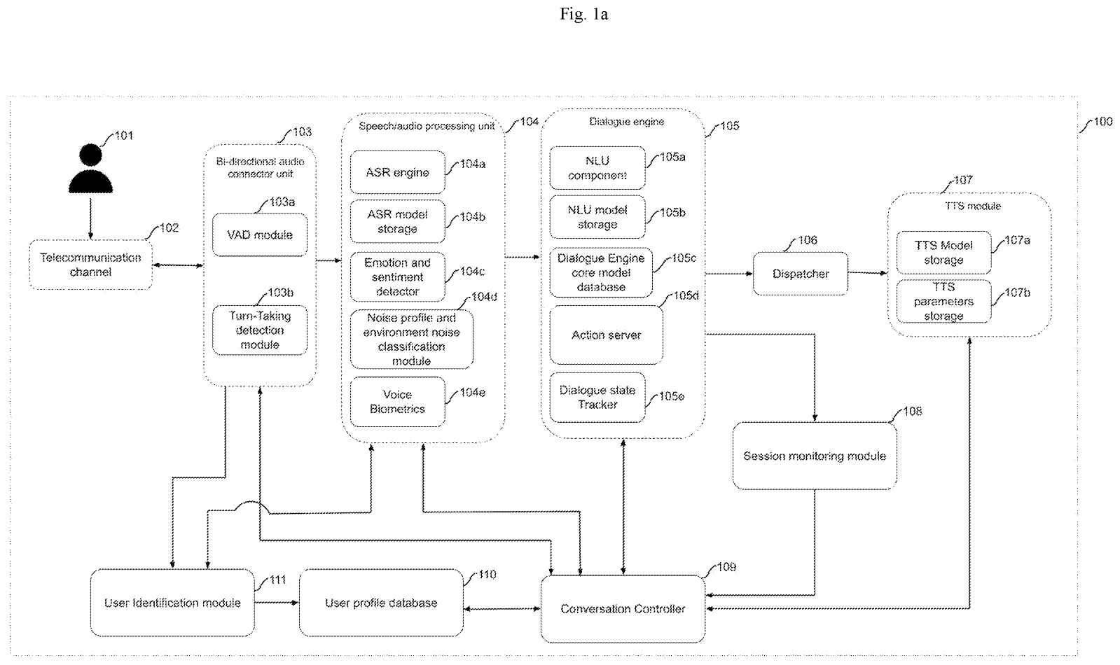

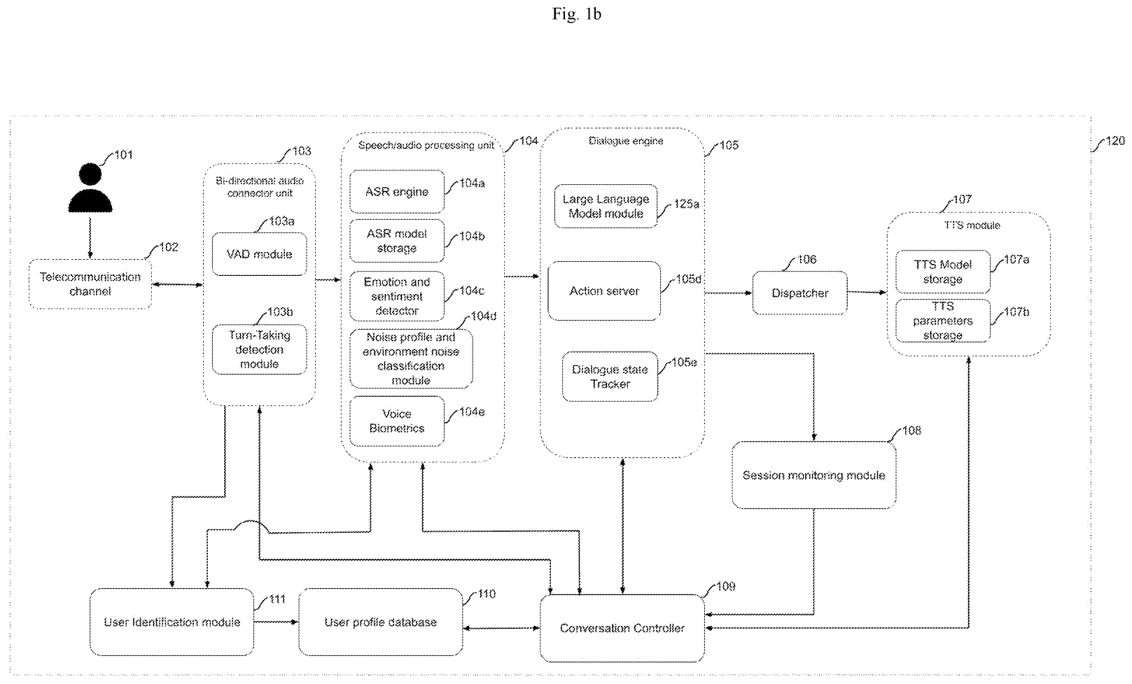

FIG. 1 illustrates a conceptual diagram illustrating an example framework for overall data flow between a human and an exemplary Interaction voice response (IVR) communication system 100 for monitoring and optimizing a user interaction session in accordance with one or more aspects of the present invention. In this example, the disclosed system herein includes a bi-directional audio connector unit 103, a speech and audio processing unit 104, a dialogue engine 105, a dialogue engine dispatcher 106, a Text-to-Speech (referred to as TTS hereafter) module 107, a session monitoring module 108, a conversation controller module 109, a user profile database 110, and a user identification module 111. The audio connector unit 103 further includes a Voice Activity Detector (referred to as VAD hereafter) module 103a and a speech turn detection module 103b. The speech audio processing unit 104 further includes an ASR engine 104a, an ASR model database 104b, an emotion and sentiment recognition module 104c, a noise profile and environmental noise classification module 104d and a voice biometrics module 104e. The dialogue engine 105 further includes an NLU component 105a, an NLU model database 105b, a dialogue engine core models database 105c, dialogue engine components and action server module 105d, and a dialogue state tracker module 105e. The TTS module 107 further includes a TTS model storage 107a and TTS parameter database 107b. The dialogue engine (105) receives and processes transcripted text corresponding to the conversation data and stores corresponding dialogue engine components and NLU (Natural Language Understanding) models to handle voice-based interactions with the user in the user interaction session.

It is to be appreciated, however, other non-illustrated components may also be included, that some of the illustrated components may not be present in every device capable of employing aspects of the present disclosure. Further, some components that are illustrated as a single component may also appear multiple times in a single device.

According to an example embodiment of the present invention, a user 101 initiates a call to the IVR communication system 100 using a client device. The client device is not illustrated herein for simplicity. The client device may correspond to a wide variety of electronic devices. According to an example embodiment of the present invention, the client device is a smartphone or a feature phone or any telecommunication device such as an ordinary landline phone. The client device acts as a service request means for inputting a user request.

According to yet another embodiment of the present invention, the user 101 from the client device is communicated to the IVR communication system 100 using an application over the smartphone using data services which may or may not use a telecommunication network.

Referring back to FIG. 1, the call from user 101 is communicated to the IVR communication system 100 through the telecommunication channel 102. The telecommunication channel 102 routes the call to the bi-directional audio connector unit 103. The bi-directional audio connector unit 103 further connects to the user identification module 111 for authenticating a user, such as user 101, into the IVR communication system 100. The user identification module 111 links and registers users to the IVR communication system 100 and verifies and maintains their identification information. The user identification module 111 further stores information about the user, in the corresponding user profile in the user profile database 110, for providing a plurality of personalized services. The user identification module 111 identifies and/or registers the user 101 using the user's 101 caller number and/or a unique identification number assigned to the user 101 when the user 101 is pre-registered. The user identification module 111 is further configured to further configured to distinguish between synthesized speech and the user's human voice in the received conversation data from the user's stored voice biometrics for detection of any fraudulent activity. The user identification module 111 is further configured to store and update user profiles with past and present interaction session status and call session statistics, ASR models, dialogue engine models and TTS models corresponding to the existent user profiles.

According to yet another embodiment of the present invention, the user identification module 111 is further configured to initiate the conversation controller module 109 once the user 101 is successfully authenticated into the IVR communication system 100.

Referring back to FIG. 1, the conversation controller (109) is capable of triggering actions based on analysis obtained to perform desired intent fulfillment operation. The conversation controller module 109 obtains a plurality of user data of the user 101, from the corresponding user profile in the user profile database 110 when a user interaction session is initiated. The user profile database 110 stores information associated with the users, such as past and present conversation statistics, and user preferences, such as, for example, but not limited to, the best-suited ASR models, NLU models, dialogue engine models and TTS models e.t.c. for the user. The user profile database 110 further stores past statistical data and current call statistics, corresponding to user interaction sessions, received from the conversation controller module 109. The conversation controller module (109) receives the audio features and chooses and/or modifies associated ASR and NLU models for the user interaction session to optimize the user interaction session duration. The conversation controller (109) is further configured to choose and modify models associated with determining speech segments, non-speech segments, turn-taking speech segments and barge-in speech segments to accomplish a targeted service. The forms and/or slots are populated with service-oriented information received from the user to accomplish the goal and/or a targeted service. The conversation controller module (109) receives the audio features and processes outputs of ASR and NLU to optimize the user interaction session duration. According to an embodiment of the present invention, the conversation controller may suggest the TTS to increase the rate of speech. According to yet another embodiment, the conversation controller may suggest the TTS to decrease the rate of speech.

Furthermore, receiving and analyzing conversation data and audio features from user speech input further comprises authenticating the user to a user interaction session using the user's caller number or a unique identification number assigned to the user.

The conversation controller module 109 is further configured to update the user profile corresponding to each user during every user interaction session and communicate the data accordingly for optimization of the user journey. The conversation controller module 109 is further configured to assign and/or modify a plurality of thresholds for determining speech segments, and non-speech segments, in the received audio signal corresponding to the speech input of the user 101 such as, a non-speech detection threshold, a final non-speech detection threshold, a non-speech duration threshold, an activation threshold for detecting start of speech, a deactivation threshold for detecting end of speech, and a user timeout threshold e.t.c.

The conversation controller module 109 further updates and/or modifies a plurality of user attributes corresponding to the user's 101 profile in the user profile database 110, after each user interaction session. The plurality of user attributes include, for example, but is not limited to, the user's level of expertise, user's speaking rate, non-speech detection window duration, preferred set of conversation path options, conversation breakdown length for lengthy information, model choice for corresponding ASR, dialogue engine, NLU, TTS, and furthermore, average negative sentiment, emotion score, and happiness index for the user. The speech processing unit (104) is further configured to detect and analyze at least one of emotion, sentiment, noise profile and environmental audio information from the received audio data features.

According to a non-limiting exemplary scenario for one of the embodiments of the present invention, if after following an analysis of past and present user interactions, it is determined that the user 101 is often facing difficulty completing his speech input in a turn window, then, the conversation controller module 109 is capable of increasing the non-speech detection window duration threshold. The non-speech detection window duration threshold can be modified both during or after the corresponding user interaction session. Furthermore, per user non-speech threshold preference is stored in the corresponding user profile in the user profile database 110.

Referring back to FIG. 1, the user profile database 110 further stores a plurality of identifiers for the users such as the user 101. The plurality of identifiers may include but not limited to, for example, user IDs, usernames, and other self-identifying information for the user including one or more parameters, without limitation, such as, for example, a personal identification number, social security number, and/or voice biometrics voice prints. The user profile database 110 may also store user demographic information corresponding to each user, such as user's age, gender, occupation, education information (e.g., education level, degrees etc.), or one or more locations associated with users (e.g., the user's home, the user's places of work, places the user frequently visits, etc.). The speech and audio processing unit 104 is further configured to utilize voice biometrics to identify and register the user participating in the user interaction session using a voice biometrics module 104e. Furthermore, authenticating a user to the user interaction session using the user's caller number or a unique identification number assigned to the user further comprises the step of utilizing voice biometrics to identify and register the user participating in the user interaction session.

The VAD module 103a included in the bi-directional audio connector unit 103 identifies and parses the audio segment received from the user's 101 speech input in the user interaction session into speech segments and non-speech segments. The turn-taking detection module 103b in the bi-directional audio connector unit 103 identifies and parses the received audio segments for start of speech, turn-taking, and end of speech within the user interaction session with the user 101. The bi-directional audio connector unit (103) determines and stores at least one of the speech segments, non-speech segments, turn-taking speech segments and barge-in speech segments in the user interaction session. The bi-directional audio connector unit 103 is further configured to identify and parse the audio segment received from the user's 101 speech input in the user interaction session into speech segments and non-speech segments using a Voice Activity Detector (referred to as VAD hereafter) module 103a.

Furthermore, the identification of speech segments, non-speech segments, start-of-speech, end-of-speech, turn-taking and user timeout in the received audio data or an audio recording of the user's speech input during the interaction session (e.g. a telephone call that contains speech) facilitates increased accuracy in transcription, diarization, speaker adaptation, and/or speech analytics of the audio data. Furthermore, the speech turn detection module 103b is used in order to reduce the waiting time of the user by detecting the end time point in the user's 101 speech input. The bi-directional audio connector unit 103 further connects to the conversation controller module 109 and is capable of receiving VAD and speech turn-taking preferences associated with the user's 101 profile once the user 101 is authenticated into the IVR communication system 100. The conversation controller module 109 is further configured to assign and modify thresholds for determining speech segments, non-speech segments, start-of-speech, end-of-speech, turn-taking and user timeout.

The user's 101 speech input is then routed to the speech/audio processing unit 104 of the IVR communication system 100. The speech/audio processing unit 104 corresponds to the ASR engine 104a. One skilled in the art would recognize that the ASR engine 104a is capable of receiving and translating the voice input signal from the user's 101 speech input into a text output. The ASR translation text represents the voice input signal's best analysis of the words and extra dialog sounds spoken in the user's 101 speech input using a corresponding ASR model best suited to the user 101. The conversation controller module 109 further connects to the speech/audio processing unit 104. The conversation controller module 109 receives and analyzes the derived audio statistics from the ASR engine and assigns the best suited ASR model for the user 101. The conversation controller module 109 is further configured to update the ASR model preference in the user's 101 profile information in the user profile database 110 for optimization of the interaction session. Furthermore, the conversation controller module 109 is also capable of assigning the corresponding ASR model to the user 101 for the interaction session without analyzing the audio statistics when there is no new and/or updated information corresponding to the ASR model available in the user's 101 profile. The conversation controller module 109 selects the ASR model for the interaction session assigned for the user 101 as per the user profile information available in the corresponding user profile database 110. The speech/audio processing unit 104 corresponds to a plurality of ASR models stored in an ASR model storage 104b storing large vocabulary speech input recognitions for use during recognition in the user interaction session. The speech/audio processing unit 104 is further capable of analyzing the user's 101 speech input using the emotion and sentiment recognition module 104c, for tracking and analyzing emotional engagement of the user during the user interaction session and calculating corresponding emotion score and sentiment score, such as, for example, detecting emotions, moods, and sentiments e.t.c. of the user 101. The speech/audio processing unit 104 is also capable of analyzing the audio data from the received user's 101 speech input from background noise using a noise profile and environmental noise classification module 104d configured for distinguishing speech from background noise in the received. The speech processing unit (104) receives and analyzes conversation data and audio data features from a user speech input, and stores ASR (Automated Speech Recognition) models corresponding to the user interaction session.

In a non-limiting exemplary scenario for one of the embodiments of the present invention, when the background noise and environmental noise level for the caller is detected to be higher than a threshold predetermined by the conversation controller module 109, the conversation controller module 109 is capable of choosing a model dialogue engine 105 with a slow speaking rate, and configured to repeat portions of the dialogue engine to improve user experience with the IVR communication system 100. Furthermore, the conversation controller module 109 is capable of choosing an alternate noise-robust ASR model for the user rather than assigning the regular ASR, such as, for example, a noise-robust ASR model that generally does not perform well on clean audio data compared to the regular ASR but, however, performs better than the regular ASR for noisy audio data.

Furthermore, if detected that the user 101 is struggling to provide long numerical inputs due to the background and environmental noise or speaking features, the conversation controller module 109 modifies the corresponding dialogue engine model to design an alternate conversation path and breaking down the conversation for the user, such as, for example, but not limited to, allowing the user to speak 2 digits at a time or 5 digits at a time. The conversation controller module 109 stores the modified dialogue engine model as a user preference corresponding to the user's 101 profile in the user profile database 110.

Furthermore, the conversation controller module 109 is also configured to modify corresponding dialogue engine models to adjust speaking rate as per the user preference also. If user utterances in the speech input includes sentences that say, for example, “Please utter slowly” or “Please speak faster” during the interaction session, the controller module 109 modifies the speaking rate for the model associated with the dialogue engine 105 accordingly. The conversation controller module 109 stores the preferred average speaking rate for the user 101 in the corresponding user profile in the user profile database 110. Furthermore, if user utterances in the speech input includes sentences that say, for example, “Please repeat”—, the conversation controller module 109 modifies the model associated with dialogue engine 105 and repeats the relevant information at a 0.9× rate for example. However, if it is determined the user still cannot understand even after a couple of repetitions, then the dialogue engine 105 utterance is flagged for reviewing the pronunciation.

Referring back to FIG. 1, the voice signal received from the user's 101 speech input is further analyzed using the voice biometrics module 104e. The voice biometrics module 104e corresponds to a voice biometrics system adapted to authenticate a user based on speech diagnostics corresponding to the received speech audio input. The voice biometrics module 104e further connects to and performs user authentication for, the user identification module 111. The user identification module authenticates the user to a user interaction session using the user's caller number or a unique identification number assigned to the user.

The voice biometrics module 104e verifies one or a plurality of voice prints corresponding to the audio signal from the user's 101 speech audio input received in the interaction session against one or a plurality of voice prints of the user 101 stored from past interaction sessions. The voice prints are stored in the user profile associated with user 101 in the user profile database 110. The voice biometrics module 104e compares the one or plurality voiceprints for authentication of the user 101 into the IVR communication system 100.

The speech/audio processing unit 104 further connects to the dialogue engine 105. One skilled in the art would recognize that the dialogue engine 105 is capable of receiving transcribed text from the speech/audio processing unit 104 and carrying out corresponding logic processing. The dialogue engine 105 further drives the speech/audio processing unit 104 by providing a user interface between the user 101 and the services mainly by engaging in a natural language dialogue with the user. The dialogues may include questions requesting one or more aspects of a specific service, such as asking for information. In this manner the IVR communication system 100 may also receive general conversational queries and engage in a continuous conversation with the user through the dialogue engine 105. The dialogue engine 105 is further capable of switching domains and use-cases by recognizing new intents, use-cases, contexts, and/or domains by the user during a conversation. The dialogue engine 105 keeps and maintains the dynamic structure of the user interaction session as the interaction unfolds. The context, as referred to herein, is the collection of words and their meanings and relations, as they have been understood in the current dialogue in the user interaction session.

The dialogue engine 105 further includes the NLU component 105a. One skilled in the art would recognize that the NLU component is capable of receiving input from the dialogue engine 105 and translating the natural language input into machine-readable information. The NLU component determines and generates transcribed context, intent, use-cases, entities, and metadata of the conversation with the user 101. The NLU component corresponds to a plurality of NLU models stored in the NLU models storage 105b and uses natural language processing to determine use-case from the user's speech input as conversational data. The dialogue engine 105 further comprises at least one of the said NLU component 105a, an NLU model storage 105b, a dialogue engine core model database 105c, an action server 105d, and the dialogue state tracker 105e arranged within the dialogue engine 105.

The dialogue state tracker module 105e is configured to track the “dialogue state”, including, for example, providing hypotheses on the current state and/or analyzing the conviction state of the user's 101 goal or intent during the course of the user interaction session in real-time. The dialogue state tracker 105e appends information related to the user interaction session When determining the dialogue state, the dialogue state tracker module 105e determines the most inclined value for corresponding slots and/or forms applicable in the dialogue based on the user's 101 speech input in the user interaction session and corresponding conversational data models. The slots act as a key-value store which is used to store information the user 101 has provided during the interaction session, as well as additional information gathered including, for example, the result of a database query. There can be a plurality of types of slots such as, but not limited to, a text slot, a Boolean slot, a categorical slot, and a float slot. According to one of the embodiments of the present invention, the slot values are capable of influencing the interaction session with the user 101 and influencing the next action prediction. The dialogue engine 105 is further configured to carry out the applicable system action and populate the applicable forms and/or slots corresponding to the user interaction session using an action server 105d.

Referring back to FIG. 1, the dialogue engine 105 further uses the dialogue engine core model storage 105c to determine a conversation action for the user in the user interaction session. The dialogue engine core model storage 105c further includes a prediction system for feeding the dialogue engine components and actions server 105d with predicted conversation and response actions and conversational path designs. The predicted response and conversation actions and conversational path designs include, but are not limited to, for example: generating a transcription for a spoken response, querying a corresponding database, or making a call, generating at least one of a plurality of forms and/or slots, and validating the one or the plurality of forms and/or slots in the user interaction session. The plurality of forms and slots are used for better expression of the intent of the user, and each slot in a corresponding conversation data model is populated through user interaction by the dialogue engine components and action server 105d. The dialogue engine core model storage 105c provides a flexible dialogue structure and allows the user 101 to fill multiple slots in various orders in a single user interaction session. The dialogue engine components and action server 105d associated with the corresponding dialog engine core model executing the application further uses the conversation data model to track the conversation context and historic information, determine which slots are filled with information from the user, and determine which slots need to be presented to complete a corresponding form.

In yet another embodiment of the present invention, the slots are defined as to not influence the flow of the interaction session with the user 101. In such a non-limiting exemplary scenario, the conversation controller module 109 receives the information associated with the slots and/or forms and stores them in the user profile corresponding to the user 101 in the user profile database 110. The applicable forms and/or slots are populated to add personal dialogue history information to the dialogue state tracker 105e.

Referring back to FIG. 1, the conversation controller module 109 further connects to the dialogue engine 105. The conversation controller module 109 receives and analyzes the processed conversation data from the dialogue engine 105 corresponding to the user interaction session. The conversation controller module 109 then derives explicit user preferences for the NLU model, the dialogue engine, the dialogue engine core model and modifies the corresponding conversation data model for the user 101 within the user interaction session. The user profile of the user 101 in the user profile database 110 is then updated with corresponding user preferences by the conversation controller module 109. Furthermore, the preferences are executed in the user interaction session in real-time and also stored for optimization of future user interaction sessions with the user 101 by the conversation controller module 109.

The dialogue state tracker module 105e further connects to the session monitoring module 108. The session monitoring module 108 determines the session state of the user interaction session and is further configured to record session state related information between the user 101 and the service instance. For example: user name, client, timestamp, session state, etc.; the session states are: login, active, disconnected, connected, logoff, etc. The session monitoring module 108 is further configured to add session ID for the corresponding user interaction session, add user metrics, and also to calculate an explicit and automatic happiness index for the user's 101 during the interaction session. The happiness index is calculated by applying weight to each type of information based on information received during the user interaction session with the user 101.

The session monitoring module 108 further connects to the conversation controller module 109. The conversation controller module 109 is further configured to receive the conversational statistics derived by the session monitoring module 108 such as, for example, but not limited to, the happiness index score, user session metrics and aggregated user session metrics corresponding to session ID associated with the user 101 for optimization of the user's 101 journey. The conversation controller module 109 further updates the user profile of the user 101 in the user profile database 110 with the corresponding happiness index score, user session metrics and aggregated user session metrics. The session monitoring module monitors the user interaction session and adds key metrics corresponding to the user interaction session to the conversation controller module 109. The key metrics added include at least one of confidence scores, users level of expertise, number of application forms/slots, conversation length, fall back rate, retention rate, and goal completion rate.

The conversation controller module 109 is further configured to make necessary modifications based on the received conversational statistics in order to optimize the user interaction session. The conversation controller 109 is also further configured to assign and modify thresholds for determining non-speech segments.

The conversation controller 109 is further configured to select and/or modify a conversation data model based on the received audio features and/or an existing user profile.

In a non-limiting exemplary scenario for one of the embodiments of the present invention, the scores corresponding to emotion and sentiment detected from the user's 101 speech audio input and the user's 101 engagement is used to infer an average satisfaction level of the user 101. The conversation controller module 109 is capable of comparing the inferred satisfaction level against the happiness index score provided by the user 101. The conversation controller module 109 then aims for modification of corresponding parameters, such as, for example, the models associated with the dialogue engine 105 in order to optimize the user interaction session. dialogue engine 105 is further configured to predict an applicable system action based on the received conversation data using a dialogue engine core model storage 105c; wherein said applicable system action includes at least one of the following:
generating a transcription for a spoken response;
querying a corresponding database or making a call;
generating at least one of a plurality of forms and/or slots; and
validating the one or the plurality of forms and/or slots.

The applicable system action for the conversation data is determined using at least one of the Transformer Embedding Dialogue (TED) Policy, Memoization Policy, and Rule Policy.

Furthermore, in another non-limiting exemplary scenario for one of the embodiments of the present invention, based on the user expertise level of a plurality of users and their corresponding past session metrics uniquely, alternate conversation paths are chosen by the conversation controller module 109. A plurality of conversation path options are tested for a user by the conversation controller module 109, and based on corresponding session metrics, the preferred conversation paths are stored in the user profiles of the associated users in the user profile database 110. This is executed via inference of preferred conversation path options based on the sessions where the conversation controller module 109 instructed the dialogue engine to test different options of conversation paths for the user.

Furthermore, in another non-limiting exemplary scenario, a feedback classifier model is included using the user's reaction compared to his experience in a happiness-index feedback block. A plurality of various dependent parameters are adjusted based on the response category by the conversation controller module 109. The conversation controller module 109 further stores the corresponding parameters in the corresponding user profile associated with the user in the user profile database 110 for future optimization.

Furthermore, in another non-limiting exemplary scenario, in case of modification of a model associated with the dialogue engine based on users level of expertise, after a plurality of successful user interaction sessions, the conversation controller module 109 increases the speaking rate. If it is determined that the user 101 doesn't face any challenge at the increased speaking rate, the conversation controller module 109 stores the speaking rate as the preferred rate for the corresponding associated with the user profile. If it is determined otherwise, it would be reverted to the original speaking rate or decreased as well.

Referring back to FIG. 1, the dialogue state tracker module 105e further connects to the dialogue engine dispatcher 106. The dialogue engine dispatcher 106 is configured to receive the response actions input from the dialogue state tracker module 105e and generate and deliver a corresponding response in the form of one or a plurality of text message information to the TTS module 107. The dialogue engine dispatcher 106 is further capable of storing a plurality of responses in queue until delivered to the TTS module 107. The dialogue engine dispatcher generates a response corresponding to the user's intention during the user interaction session.

The TTS module 107 receives the responses and recognizes the text message information. The TTS module 107 applies corresponding TTS models and corresponding TTS parameters from the TTS model storage 107a and TTS parameters database 107b respectively, to perform speech synthesis and create voice narrations. The TTS model storage 107a stores a plurality of TTS models including phonemes of text and voice data corresponding to phonemes in natural language speech data and/or synthesized speech data. The TTS parameters database 107b carries parameters related to voice attributes of the audio speech response output including, but not limited to, language type, voice gender, voice age, voice speed, volume, tone, pronunciation for special words, break, accentuation, and intonation e.t.c. As a result, the TTS module 107 converts the received response from the dialogue engine dispatcher 106 into an audio speech response for the user 101. The TTS module (107) receives the generated response and performs speech synthesis. The process of performing speech synthesis on the generated responses further comprises storing TTS models and TTS parameters such as, speaking rate, pitch, volume, intonation, and preferred responses corresponding to the user interaction session.

The TTS module 107 further connects to the conversation controller module 109. The conversation controller module 109 is further configured to select the assigned TTS model for the user interaction session according to the user preference stated in the corresponding user profile of user 101 in the user profile database 110. The conversation controller module 109 is further configured to modify and update the corresponding TTS model preference in the user profile of user 101 in the user profile database 110 for optimization of the interaction session.

In a non-limiting exemplary scenario for one of the embodiments of the present invention, based on the user's 101 emotion score, the conversation controller module 109 chooses a suitable TTS model. The TTS model corresponds to a different voice such as, for example, if the user 101 sounds angry, then the conversation controller module 109 chooses a TTS model that corresponds to an empathetic voice.

In another exemplary embodiment of the present invention, a Large Language Model module 125a (referred to as “LLM module” hereafter) is included in the dialogue engine 105. FIG. 1B depicts a conceptual diagram illustrating an example framework for the overall data transmitted and received in an interaction session between a human user and an exemplary Interactive voice response (IVR) communication system 120 for monitoring and optimizing the user interaction session in such embodiment. In this example, the disclosed system herein includes a LLM module 125a in the IVR communication system 120 in FIG. 1B. For illustration purposes only, in this exemplary embodiment, the LLM module 125a is a large scale language model to determine use-case from the user's speech input as conversational data and generate a reply text based on the conversational data information received. Furthermore, for flexibility in execution of tasks, including generating replies, a set of rules, task description and formatting instructions on the basis of prompts in natural language are introduced to the LLM module 125a to follow. In this exemplary embodiment, the LLM language model is capable of benefiting the IVR communication system 120 to interpret the user's 101 natural language input more efficiently and provide support for continuous optimization and updating of the IVR communication system 120. In this exemplary embodiment, the dialogue engine 105 is capable of receiving transcribed text from the speech/audio processing unit 104 and carrying out corresponding logic processing using the LLM module 125a. The dialogue engine 105 comprises at least one of a Large Language Module 125s, an action server 105d and the dialogue state tracker 105e arranged within the dialogue engine 105.

The dialogue engine 105 further drives the speech/audio processing unit 104 by providing a user interface between the user 101 and the services mainly by engaging in a natural language dialogue with the user by means of the LLM module 125a. The dialogues may include questions requesting one or more aspects of a specific service, such as asking for information for understanding the user's 101 intents with improved accuracy. In this manner the IVR communication system 120 may also receive general conversational queries and engage in a continuous conversation with the user through the dialogue engine 105. Using the LLM module 125a, the dialogue engine 105 is further capable of producing coherent sentences, taking into account the user's input, generating responses that align with the conversation's trajectory, participating in multi-turn conversations and handling open-ended queries. Furthermore, in cases where the dialogue engine 105 has to provide translations of user inputs or summarize lengthy responses, switch domains and use-cases by recognizing new intents, use-cases, contexts, and/or domains by the user during a conversation, the LLM module 125a helps guide the interaction session in the user's intended direction and the action server 105d generates prompts that provide the LLM module 125a with the necessary context and information for generating personalized, coherent and relevant responses. Furthermore, after receiving a generated text response from the LLM module 125a, the action server 105d is capable of performing post-processing to refine the generated text. The post-processing involves removing redundant information, formatting the text, or adding additional context.

The action server 105d, along with slot tracking, is further capable of interfacing with external APIs, sending requests, receiving responses, and integrating the information into the conversation within the interaction session.

Furthermore, using the LLM module 125a and the action server 105d, the dialogue engine 105 keeps and maintains the dynamic structure of the user interaction session, as the interaction unfolds, making the interaction feel more like a human-to-human conversation. The context, as referred to herein, is the collection of words and their meanings and relations, as they have been understood in the current dialogue in the user interaction session.

The dialogue state tracker module 105e is configured to track the “dialogue state”, including, for example, providing hypotheses on the current state and/or analyzing the conviction state of the user's 101 goal or intent during the course of the user interaction session in real-time. When determining the dialogue state, the dialogue state tracker module 105e determines a most inclined value for corresponding slots and/or forms applicable in the dialogue based on the user's 101 speech input in the user interaction session and corresponding conversational data models. Furthermore, working alongside the action server 105d and the LLM module 125a in the dialogue engine 105, the dialogue state tracker 105e coordinates interactions and ensures coherent and contextually relevant conversations. The dialogue state tracker 105e works closely with the action server 105d to identify which slots are required to complete an intent or task and keeps track of the context of the conversation, including the user's previous inputs, system responses, and any relevant information that has been exchanged. This helps ensure that the conversation within the interaction session remains coherent and relevant over multiple turns. During the user interaction session with the user 101, the dialogue state tracker 105e updates the dialogue state with new information. For example, if the user provides a response that fills a slot in a form, the dialogue state tracker 105e records this information. The dialogue state tracker 105e helps in determining when to invoke the action server 105d to collect missing information and when to involve the LLM module 125a to generate a response. The dialogue state tracker 105e provides necessary information to both the LLM module 125a and the action server 105d to ensure a seamless interaction session.

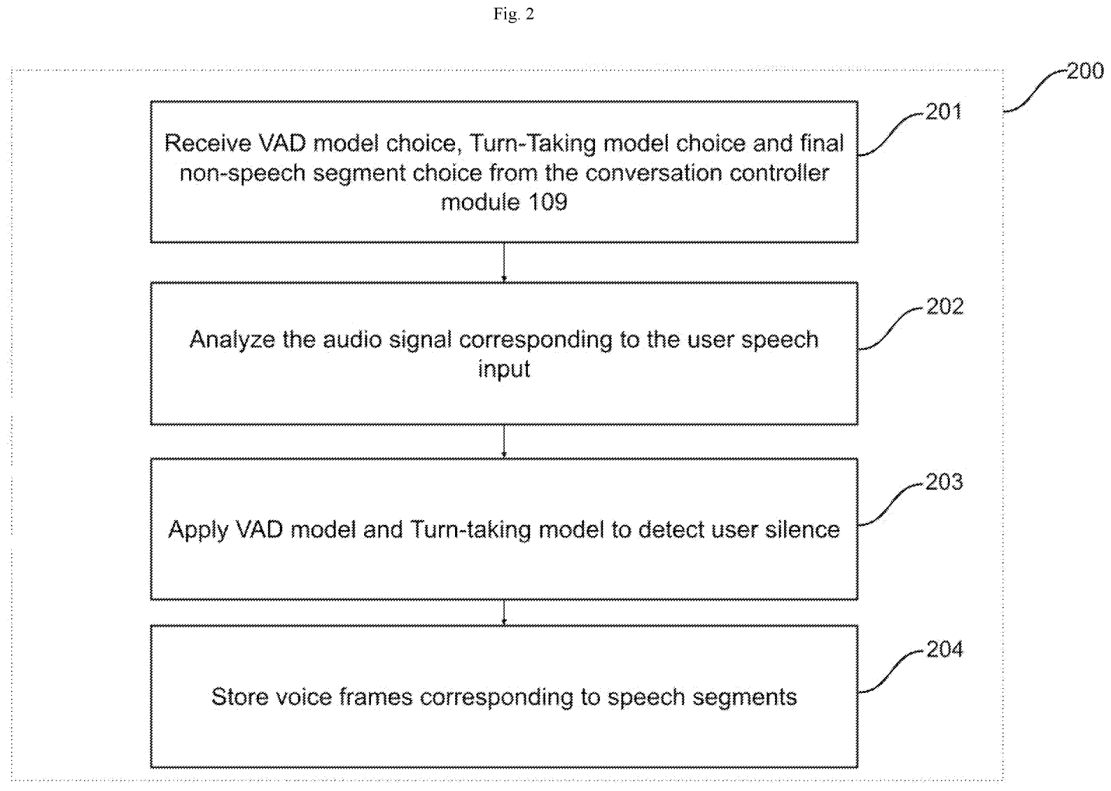

FIG. 2 is a flowchart 200, in the context of the IVR communication system 100 illustrated in FIG. 1, illustrating a flow for an exemplary speech and/or non-speech segment detection process in an exemplary scenario.

At step 201, the user interaction session is initiated with the user 101 and the conversation controller module 109 determines and selects or modifies the VAD model and the turn-taking model assigned for the user 101 corresponding to the user profile in the user profile database 110. The conversation controller module 109 further determines and selects a final non-speech segment threshold for determining the non-speech segment in the received audio signal corresponding to the speech input of the user 101. The non-speech segment is detected based on comparison with the predetermined final non-speech segment detection threshold value.

In the next step, at step 202, the audio signal corresponding to the user speech input from the user 101 is received over the telecommunication channel 102. The bi-directional audio connector unit 103 further analyzes the audio signal during the user interaction session.

In the next step, at step 203, the corresponding VAD model and the turn-taking model, determined and selected at step 201, is used to detect and identify speech segments, non-speech segments, start-of-speech, end-of-speech, turn-taking and user timeout in the received audio data of the user interaction in real-time.

In a non-limiting exemplary scenario for one of the embodiments of the present invention, the core of speech and/or non-speech segment detection decision-making is represented by the VAD module 103a in combination with a Sliding Windows approach. For example, each incoming audio frame of, for example, 20 msec length that arrives in the bi-directional audio connector unit 103 is classified by the VAD tool. The VAD module 103a is currently capable of being executed using a plurality of interfaces, such as Google's WebRTCVAD. The VAD tool 103a further determines if the audio frame is voiced or not. The audio frame and the classification result are inserted into a Ring Buffer (not illustrated herein for simplicity) configured with a specified padding duration in, for example, milliseconds. The ring buffer is implemented in the Sliding Windows VAD class, and is responsible for implementing at least one of the following interfaces: “Active Listening Checker” interface “checkStart (AudioFrame frame)” interface, and “checkEnd (AudioFrame frame)” interface.

The properties corresponding to speech segments and non-speech segments are further defined and stored in a database (not illustrated herein for simplicity) comprising a plurality of models associated with speech segments and non-speech segments.

For example, in case of “start of speech” segment detection, when the incoming audio frames, comprising speech, in the ring buffer are more than an activation threshold times a maximal buffer size, it is detected that the user 101 has started to speak. In such a case, all the incoming audio frames in the ring buffer are sent to the ASR engine as well as all following incoming audio frames until the end of speech of the user 101 is detected.

Furthermore, in case of an end-of-speech segment detection, when the user is speaking, new frames are inserted into the ring buffer over a “checkEnd” method. After inserting the new frame, the turn-taking module 103b module 103a determines if the number of non-speech frames is greater than a deactivation threshold times the maximal buffer size. In such a case, the turn-taking module 103b will decide a “USER_HAS_STOPPED_SPEAKING” state.

Furthermore, in the case of final non-speech segment detection, during the turn-taking corresponding to the USER_HAS_STOPPED_SPEAKING state, the VAD module 103a determines if the final non-speech threshold has been reached by comparing the current time with the timestamp of the last end-of-speech event or if the user 101 has started to speak again. The start of speech detection works as aforementioned in paragraph [57]. If the VAD module 103a determines the final non-speech segment threshold has been reached, the ASR engine is informed correspondingly and the transcription results are then awaited. The current user 101 turn is then decided to complete.

For example, when the user 101 has stopped speaking, the user 101 has to be detected before the final non-speech segment threshold is reached, such as, with an example predetermined default configuration and a final non-speech segment threshold of 1500 msec, the user 101 has to start to speak again after around 1200 msec so that the speech input would be detected before the final non-speech segment threshold has been reached. This is because the ring buffer has to contain activation threshold times max ring buffer size frames comprising speech, so that the user 101 speech input is detected and also to further include some room for classification errors/true negatives, which may lead to, for example, 300 msec. Furthermore, in case of user timeout detection, when the IVR communication system 100 is waiting for the user 101 to start to speak, there is also a timeout threshold of, for example, 5 s set in default. If start-of-speech is not detected within the 5s, a user timeout is detected by the VAD module 103a and the user 101 turn ends.

In the last step, at step 204, the voice frames corresponding to speech segments are stored in the bi-directional audio connector unit 103. The process ends at step 204, and the voice frames are then further transmitted to the ASR engine 104a in the audio/speech processing unit 104 for transcription.

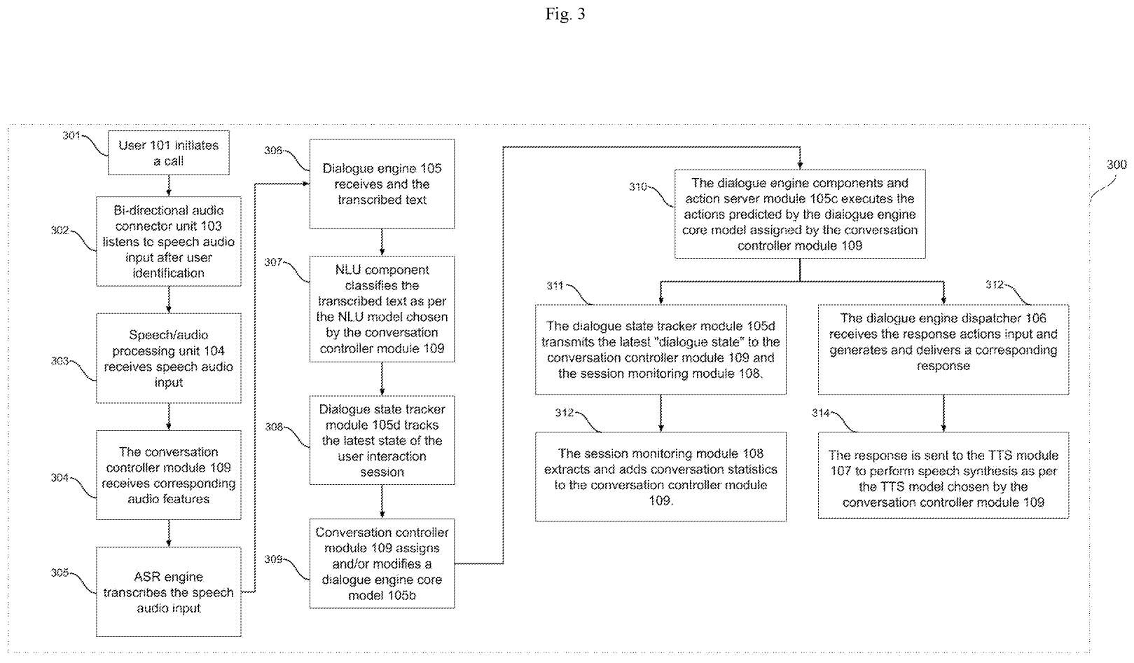

FIG. 3 is a flowchart 300, in the context of the IVR communication system 100 illustrated in FIG. 1, illustrating a flow for the conversation controller integration in an exemplary scenario.

At step 301, a user, such as user 101, initiates a call to the IVR communication system 100 through, for example, a telephony gateway. The call is transmitted to the IVR communication system 100 over the telecommunications channel 102.

In the next step, at step 302, an interaction session is established. The bi-directional audio connector unit 103 receives and analyzes the audio signal corresponding to the user speech input from the user 101 during the user interaction session. After user identification through the user's caller number or unique ID is performed, the bi-directional audio connector unit 103 stores and identifies the speech segments, non-speech segments, start-of-speech, end-of-speech, turn-taking and user timeout in the received audio data of the user interaction in real-time. The speech segments are then transmitted to the speech/audio processing unit 104.

In the next step, at step 303, the speech segments are received by the speech/audio processing unit 104 and analyzed accordingly for audio statistics such as, for example, emotion, sentiment, noise profile and environmental audio information from the received audio data features of the speech segments.

In the next step, at step 304, the conversation controller module 109 then receives and analyzes the derived audio statistics from the speech segments and assigns and/or modifies an ASR model best suited for the user interaction session corresponding to the user's 101 profile.

In the next step, at step 305, the ASR engine then transcribes the speech segments into machine readable text corresponding to the ASR model assigned by the conversation controller module 109. The transcribed machine readable text is then transmitted to the dialogue engine 105.

In the next step, at step 306, the dialogue engine 105 receives the transcribed machine readable text. The conversation controller module 109 further assigns and/or modifies an NLU model based on the derived audio statistics received from the speech segments, at step 304, and best suited for the user interaction session and corresponding to the user's 101 profile in the user profile database 110.

In the next step, at step 307, the NLU component classifies and grasps the domain and the user's intent in the user's speech. The NLU component further extracts entities and also classifies entity roles by performing syntactic analysis or semantic analysis. In the syntactic analysis, the user's speech is separated into a syntactic unit (e.g., word, phase, or morpheme) and the syntactic element in the separated unit is grasped. The semantic analysis is performed by using at least one of semantic matching, rule matching, or formula matching. The NLU component further performs the classification of intents, domains, entities and entity roles corresponding to the NLU model assigned by the conversation controller module 109 at step 304.

In the next step, at step 308, the dialogue state tracker module 105e tracks the “dialogue state”, including, for example, but not limited to, providing hypotheses on the current state and/or analyzing the conviction state of the user's 101 goal or intent during the course of the user interaction session in real-time. The dialogue state tracker module 105e further appends the latest “dialogue state” to the conversation data model.

In the next step, at step 309, the conversation controller module 109 further assigns and/or modifies a dialogue engine core model stored in the dialogue engine core model storage 105c and/or the conversation data model based on the derived audio statistics received from the speech segments, and best suited for the user interaction session and corresponding to the user's 101 profile in the user profile database 110. The dialogue engine core model storage 105c provides a flexible dialog structure and allows the user 101 to fill multiple slots in various orders in a single user interaction session. The dialogue engine core model, assigned by the conversation controller module 109, further predicts an applicable action for the conversation story using one or a plurality of machine learning policies, such as, for example, but not limited to, the Transformer Embedding Dialogue (TED) Policy, Memorization Policy, and Rule Policy. The Transformer Embedding Dialogue (TED) Policy is a multi-task architecture for next action prediction and entity recognition. The architecture consists of several transformer encoders which are shared for both tasks. The Memorization Policy remembers the stories from training data. The Memorization Policy includes checking if the current conversation matches the stories in the corresponding stories file. If so, the Memorization Policy will help predicting the next action from the matching stories of corresponding training data. The Rule Policy is a policy that handles conversation parts that follow a fixed behavior (e.g. business logic). It makes predictions based on any rules in corresponding training data.

In the next step, at step 310, the dialogue engine components and action server module 105d executes the actions predicted by the dialogue engine core model assigned by the conversation controller module 109. The dialogue engine components and action server module 105d runs custom actions such as, but not limited to, making API calls, database queries, adding an event to a calendar, and checking the user's 101 bank balance etc.

In the next step, at step 311, the dialogue state tracker module 105e transmits the latest “dialogue state” to the conversation controller module 109 and the session monitoring module 108. The conversation controller module 109 receives the latest “dialogue state” and updates the corresponding plurality of models and/or user preferences associated with the user profile of user 101 in the user profile database 110 accordingly with conversation statistics.

In the next step, at step 312, the session monitoring module 108 extracts and adds conversation statistics such as, for example, but not limited to, the session ID for the corresponding user interaction session, adds user metrics and also calculates an explicit and automatic happiness index for the user 101 in the user interaction session. The session monitoring module 108 extracts and adds conversation statistics to the conversation controller module 109. The conversation controller module updates the associated user profile accordingly. It is to be appreciated that step 311 and step 312 are performed concurrently according to an embodiment of the present invention.

Furthermore, after step 310, parallelly performed to step 311, at step 313, the dialogue engine dispatcher 106 receives the response actions input and generates and delivers a corresponding response in the form of one or a plurality of text message information. The dialogue engine dispatcher 106 further stores a plurality of responses in the queue until delivered accordingly.

In the next step, at step 314, the response is sent to the TTS module 107. The TTS module 107 receives the responses and recognizes the text message information. The TTS module 107 applies a corresponding TTS model and corresponding TTS parameters from the TTS model storage 107a and TTS parameters database 107b respectively, to perform speech synthesis and create voice narrations. The conversation controller module 109 further assigns and/or modifies a TTS model and corresponding TTS parameters based on the derived audio statistics received from the speech segments and best suited for the user interaction session and corresponding to the user's 101 profile in the user profile database 110.

It is to be appreciated that step 312 and step 314 are performed concurrently according to one of the embodiments of the present invention.

It is to be appreciated that the method for user interaction management for monitoring and optimizing a user interaction session comprises the steps of determining speech segments, non-speech segments, turn-taking speech segments and barge-in speech segments, receiving and analyzing conversation data and audio features from a user speech input, receiving the audio features and choosing and/or modifying associated ASR (Automated Speech Recognition) and NLU (Natural Language Understanding) models for the user interaction session, receiving and processing transcripted text corresponding to the conversation data, appending information related to the user interaction session, monitoring the user interaction session and adding key metrics, generating a response corresponding to the user's intention during the user interaction session and performing speech synthesis on the generated response.

The step of determining speech segments, non-speech segments, turn-taking speech segments and barge-in speech segments further comprises receiving assigned models for determining speech segments, receiving an assigned threshold for determining non-speech segments, listening to user speech input audio, applying the assigned models for determining speech segments, applying the assigned threshold for detecting non-speech segments; and storing and sending the speech input audio for speech processing.

Furthermore, performing speech synthesis on the generated responses also comprises the step of identifying and parsing the audio segment received from the user's 101 speech input in the user interaction session into speech segments and non-speech segments. The process further includes adjusting a speaking rate for the generated response corresponding to the received audio features and/or an existing user profile.

Furthermore, appending information related to the user interaction session includes updating and training the ASR and NLU models associated with a registered user profile using the audio data of the collection of user speech audio from the corresponding user interaction session and updating and training the models associated with determining speech segments, non-speech segments, turn-taking speech segments and barge-in speech segments associated with a registered user profile using the audio data features of the collection of user speech audio from the corresponding user interaction session. Also, appending dialogue information related to the user interaction session further includes carrying out the determined system actions and populating the applicable forms and/or slots.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practised without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

We claim:

1. A user interaction management system (100) for monitoring and optimizing a user interaction session within an interactive voice response system with a human-computer interaction, the user interaction management system (100) for monitoring and optimizing the user interaction session comprising:
a bi-directional audio connector unit (103), the bi-directional audio connector unit (103) determines and stores at least one of speech segments, non-speech segments, turn-taking speech segments and barge-in speech segments in the user interaction session;
a user identification module (111), the user identification module (111) authenticates the user to a user interaction session using the user's caller number or a unique identification number assigned to the user;
speech/audio processing unit (104), the speech processing unit (104) receives and analyzes conversation data and audio data features from a user speech input, and stores ASR (Automated Speech Recognition) models corresponding to the user interaction session;
a dialogue engine (105), the dialogue engine (105) receives and processes transcripted text corresponding to the conversation data and stores corresponding dialogue engine components and NLU (Natural Language Understanding) models to handle voice based interactions with the user in the user interaction session;
a dialogue state tracker (105e), the dialogue state tracker (105e) appends information related to the user interaction session;
a conversation controller module (109), the conversation controller module (109) receives the audio features and chooses and/or modifies associated ASR and NLU models for the user interaction session to optimize the user interaction session duration;
a session monitoring module (108), the session monitoring module monitors the user interaction session and adds key metrics corresponding to the user interaction session to the conversation controller module (109);
a dialogue engine dispatcher (106), the dialogue engine dispatcher generates a response corresponding to the user's intention during the user interaction session; and
a TTS (text-to-speech) module (107), the TTS module (107) receives the generated response and performs speech synthesis.

2. The user interaction management system (100) for monitoring and optimizing a user interaction session within an interactive voice response system during a human-computer interaction, as claimed in claim 1, wherein said conversation controller (109) is further configured to choose and modify models associated for determining speech segments, non-speech segments, turn-taking speech segments and barge-in speech segments to accomplish a targeted service.

3. The user interaction management system (100) for monitoring and optimizing a user interaction session within an interactive voice response system during a human-computer interaction, as claimed in claim 1, wherein said conversation controller (109) is further configured to assign and modify thresholds for determining non-speech segments.

4. The user interaction management system (100) for monitoring and optimizing a user interaction session within an interactive voice response system during a human-computer interaction, as claimed in claim 1, wherein said conversation controller (109) is further configured to select and/or modify a conversation data model based on the received audio features and/or an existing user profile.

5. The user interaction management system (100) for monitoring and optimizing a user interaction session within an interactive voice response system during a human-computer interaction, as claimed in claim 1, wherein said dialogue engine 105 further comprises at least one of the said NLU component 105a, an NLU model storage 105b, a dialogue engine core model database 105c, an action server 105d, and the dialogue state tracker 105e arranged within the dialogue engine 105.

6. The user interaction management system (100) for monitoring and optimizing a user interaction session within an interactive voice response system during a human-computer interaction, as claimed in claim 1, wherein said dialogue engine 105 further comprises at least one of a Large Language Module 125s, an action server 105d and the dialogue state tracker 105e arranged within the dialogue engine 105.

7. The user interaction management system (100) for monitoring and optimizing a user interaction session within an interactive voice response system during a human-computer interaction, as claimed in claim 1, wherein said dialogue engine (105) is further configured to predict an applicable system action based on the received conversation data using a dialogue engine core model storage (105c)
wherein said applicable system action includes at least one of the following:
generating a transcription for a spoken response;
querying a corresponding database or making a call;
generating at least one of a plurality of forms and/or slots; and
validating the one or the plurality of forms and/or slots.

8. The user interaction management system (100) for monitoring and optimizing a user interaction session within an interactive voice response system during a human-computer interaction, as claimed in claim 7, wherein said applicable system action for the conversation data is determined using at least one of Transformer Embedding Dialogue (TED) Policy, Memoization Policy, and Rule Policy.

9. The user interaction management system (100) for monitoring and optimizing a user interaction session within an interactive voice response system during a human-computer interaction, as claimed in claim 1, wherein said speech processing unit (104) is further configured to detect and analyze at least one of emotion, sentiment, noise profile and environmental audio information from the received audio data features.

10. The user interaction management system (100) for monitoring and optimizing a user interaction session within an interactive voice response system during a human-computer interaction, as claimed in claim 7, wherein said dialogue engine (105) is further configured to carry out the applicable system action and populate the applicable forms and/or slots corresponding to the user interaction session using an action server (105d).

11. The user interaction management system (100) for monitoring and optimizing a user interaction session within an interactive voice response system during a human-computer interaction, as claimed in claim 10, wherein said applicable forms and/or slots are populated to add personal dialogue history information to the dialogue state tracker (105e).

12. The user interaction management system (100) for monitoring and optimizing a user interaction session within an interactive voice response system during a human-computer interaction, as claimed in claim 1, wherein said user identification module (111) is further configured to distinguish between synthesized speech and the user's human voice in the received conversation data from the user's stored voice biometrics for detection of any fraudulent activity.

13. The user interaction management system (100) for monitoring and optimizing a user interaction session within an interactive voice response system during a human-computer interaction, as claimed in claim 1, wherein said user identification module (111) is further configured to store and update user profiles with past and present interaction session status and call session statistics, ASR models, dialogue engine models and TTS models corresponding to the existent user profiles.

14. The user interaction management system (100) for monitoring and optimizing a user interaction session within an interactive voice response system during a human-computer interaction, as claimed in claim 1, wherein said speech and audio processing unit (104) is further configured to utilize voice biometrics to identify and register the user participating in the user interaction session using a voice biometrics module (104e).

15. The user interaction management system (100) for monitoring and optimizing a user interaction session within an interactive voice response system during a human-computer interaction, as claimed in claim 1, wherein said session monitoring tool (108) is further configured to determine and calculate a happiness index for the user in real-time during the user interaction session.

16. The user interaction management system (100) for monitoring and optimizing a user interaction session within an interactive voice response system during a human-computer interaction, as claimed in claim 1, wherein said bi-directional audio connector unit (103) is further configured to identify and parse the audio segment received from the user's 101 speech input in the user interaction session into speech segments and non-speech segments using a Voice Activity Detector (referred to as VAD hereafter) module (103a).

17. A method for user interaction management for monitoring and optimizing a user interaction session within an interactive voice response system during a human-computer interaction, the method for user interaction management for monitoring and optimizing a user interaction session comprising the steps of:
determining speech segments, non-speech segments, turn-taking speech segments and barge-in speech segments;
receiving and analyzing conversation data and audio features from a user speech input;
receiving the audio features and choosing and/or modifying associated ASR (Automated Speech Recognition) and NLU (Natural Language Understanding) models for the user interaction session;
receiving and processing transcripted text corresponding to the conversation data;
appending information related to the user interaction session;
monitoring the user interaction session and adding key metrics;
generating a response corresponding to the user's intention during the user interaction session; and
performing speech synthesis on the generated response.

18. The method for user interaction management for monitoring and optimizing a user interaction session within an interactive voice response system during a human-computer interaction, as claimed in claim 17, wherein the step of determining speech segments, non-speech segments, turn-taking speech segments and barge-in speech segments further comprises the steps of:
receiving assigned models for determining speech segments;
receiving an assigned threshold for determining non-speech segments;
listening to user speech input audio;
applying the assigned models for determining speech segments;
applying the assigned threshold for detecting non-speech segments; and
storing and sending the speech input audio for speech processing.

19. The method for user interaction management for monitoring and optimizing a user interaction session within an interactive voice response system during a human-computer interaction, as claimed in claim 17, wherein the step of performing speech synthesis on the generated responses further comprises the step of:
identifying and parsing the audio segment received from the user's 101 speech input in the user interaction session into speech segments and non-speech segments.

20. The method for user interaction management for monitoring and optimizing a user interaction session within an interactive voice response system during a human-computer interaction, as claimed in claim 17, wherein the step of performing speech synthesis on the generated responses further comprises the step of:
adjusting a speaking rate for the generated response corresponding to the received audio features and/or an existing user profile.

21. The method for user interaction management for monitoring and optimizing a user interaction session within an interactive voice response system during a human-computer interaction, as claimed in claim 17, wherein the step of appending information related to the user interaction session further comprises the steps of:
updating and training the ASR and NLU models associated with a registered user profile using the audio data of the collection of user speech audio from the corresponding user interaction session; and
updating and training the models associated with determining speech segments, non-speech segments, turn-taking speech segments and barge-in speech segments associated with a registered user profile using the audio data features of the collection of user speech audio from the corresponding user interaction session.

22. The method for user interaction management for monitoring and optimizing a user interaction session within an interactive voice response system during a human-computer interaction, as claimed in claim 17, wherein the step of receiving and processing transcripted text corresponding to the conversation data and handling voice-based interactions with the user in the user interaction session further comprises the step of:
predicting an applicable system action based on the received conversation data, wherein said applicable system action includes at least one of the following plurality of system actions:
generating a transcription for a spoken response;
querying a corresponding database or making a call;
generating at least of a plurality of forms and/or slots; and
validating the one or the plurality of forms and/or slots.

23. The method for user interaction management for monitoring and optimizing a user interaction session within an interactive voice response system during a human-computer interaction, as claimed in claim 17, wherein the step of appending dialogue information related to the user interaction session further comprises the step of:
carrying out the determined system actions and populating the applicable forms and/or slots.

24. The method for user interaction management for monitoring and optimizing a user interaction session within an interactive voice response system during a human-computer interaction, as claimed in claim 17, wherein the step of receiving and analyzing conversation data and audio features from user speech input further comprises:
authenticating the user to a user interaction session using the user's caller number or a unique identification number assigned to the user.

25. The method for user interaction management for monitoring and optimizing a user interaction session within an interactive voice response system during a human-computer interaction, as claimed in claim 24, wherein the step of authenticating a user to the user interaction session using the user's caller number or a unique identification number assigned to the user further comprises the step of:
utilizing voice biometrics to identify and register the user participating in the user interaction session.

26. The method for user interaction management for monitoring and optimizing a user interaction session within an interactive voice response system during a human-computer interaction, as claimed in claim 22, wherein the step of predicting an applicable system action for the conversation data uses at least one of Transformer Embedding Dialogue (TED) Policy, Memorization Policy, and Rule Policy.

27. The method for user interaction management for monitoring and optimizing a user interaction session within an interactive voice response system during a human-computer interaction, as claimed in claim 17, wherein said key metrics added include at least one of confidence scores, users' level of expertise, number of application forms/slots, conversation length, fall back rate, retention rate, and goal completion rate.

28. The method for user interaction management for monitoring and optimizing a user interaction session within an interactive voice response system during a human-computer interaction, as claimed in claim 21, wherein said applicable forms and/or slots are populated with service-oriented information received from the user to accomplish the goal and/or a targeted service.

29. The method for user interaction management for monitoring and optimizing a user interaction session within an interactive voice response system during a human-computer interaction, as claimed in claim 17, wherein the step of performing speech synthesis on the generated responses further comprises:
storing TTS models and TTS parameters such as, speaking rate, pitch, volume, intonation, and preferred responses corresponding to the user interaction session.
